(19) United States
(12) Patent Application Publication
(10) Pub. No.: US 2018/0241016 A1
(43) Pub. Date: Aug. 23, 2018

(54) POLYMER-BASED PACKAGING MATERIAL FOR LITHIUM-ION BATTERY

(71) Applicant: Racefit International Company Limited, Hong Kong (HK)

(72) Inventors: Tsz Nok Ng, Hong Kong (HK); Chi Ho Kwok, Hong Kong (HK); Chenmin Liu, Hong Kong (HK); Wai Yu Lam, Hong Kong (HK); Wing Lung Hon, Hong Kong (HK)

(21) Appl. No.: 15/896,096

(22) Filed: Feb. 14, 2018

Related U.S. Application Data
(60) Provisional application No. 62/460,104, filed on Feb. 17, 2017.

(51) Int. Cl. H01M 2/08; H01M 10/0525; H01M 2/02

(52) U.S. Cl. CPC H01M 2/08; H01M 2/0267; H01M 10/0525

(57) ABSTRACT

A packaging material 101 for Li-ion battery 100 is described herein. The packaging material 101 for Li-ion battery 100 may include an innermost hot sealing resin layer 101-a facing a core 102-a of a battery 100, an adhesive layer 101-b optionally placed at top of the innermost hot sealing resin layer and an outermost LCP layer 101-c laminated either on the innermost hot sealing resin layer 101-a directly, or on the top of the adhesive layer 101-b optionally placed at top of the innermost hot sealing resin layer 101-a. The LCP layer 101-c may have a WVTR less than or equal to 0.01 g/m²/day. Further, the innermost hot sealing resin layer 101-a may have an initial hot seal temperature in a range of 100° C.-140° C.

### CROSS-REFERENCE TO RELATED APPLICATIONS AND PRIORITY

The present application claims priority from U.S. Provisional Patent Application No. 62/460,104 dated Feb. 17, 2017, the entirety of which is incorporated herein by reference.

### TECHNICAL FIELD

The present application, in general, relates to packaging material for a lithium-ion battery, and more particularly to a polymer-based packaging material for the lithium-ion battery.

### BACKGROUND

With the advent of electronic devices including smartphones, electric vehicles and portable power banks, etc., batteries, particularly lithium-ion batteries, have been widely applied in daily life use. Typically, a battery configuration includes a package, a cathode, an anode, a separator, and an electrolyte. Performance of the battery is dependent upon the properties of the cathode, the anode, the separator as well as the electrolyte. These properties affecting the performance of the battery may include charge/discharge cycles, capacity, and voltage, etc.

Typically, the electrolyte of a battery usually contains lithium salts including but not limited to LiPF₆ and LiBF₄. Upon exposure to water, the lithium salts generate hydrofluoric acid by hydrolysis. The hydrofluoric acid may react with metallic components in the battery core cell, leading to gas formation. Eventually, the battery may swell, resulting in reduction of the capacity of the battery.

Generally, a package is provided for covering the battery. The package often acts as a container for the battery core cell, protecting the structure against external mechanical hazards. The package further prevents ambient substances from reaching the electrolyte, which is highly sensitive to water, and oxygen molecules.

In the existing art, a multi-layered package (hereinafter named as aluminum package) is available that uses aluminum as the major component. The aluminum package dominates the market of the battery packaging materials. The aluminum package is manufactured by sandwiching an aluminum film between nylon and hot sealing resin, which act as protective and sealing layers respectively. It is to be noted that the aluminum package provides the advantages including low-cost, low water permeability and minimal manufacturing requirement, etc.

In the recent times, wearable technology has opened opportunities in medicine, consumer electronics, occupational health and sports. Power sources with flexible characteristics and large energy capacities are desired because of high-energy demand in small flexible wearables such as watches, eyeglasses, and belts, etc. It is not uncommon that these devices are designed ergonomically. However, the original design of battery core cell and aluminum package in lithium-ion batteries that are commonly used in electronic devices, especially in portable devices, have taken flexibility into consideration. Specifically, aluminum tends to form wrinkles upon folding, limiting its application in flexibility battery. A significant drawback of the aluminum package is the inherent signal (e.g. RF) shielding properties of aluminum, which places restriction in forthcoming designs.

It has been observed that inherent shielding properties in the existing metalized polymer film packaging for electronics contributes to radio frequency signal loss as well as induction heating during wireless power transfer. Due to the nature of wireless power transfer, the metalized polymer may host eddy currents and generate undesirable heat directly at the surface of the battery. In the long-term, repeated bouts of heating from multiple charging cycles may negatively impact the battery chemistry and the structural integrity of the device. As a result, designers of wireless charging devices have little choice but to circumvent these issues by separating and sparsely laying out the electrical components.

As devices with built-in wireless communication are becoming more prevalent in the electronics sector, there is motivation for developing a new battery packaging material that can overcome the drawbacks of the aluminum package. Ongoing challenges in the industry include minimizing communication signal loss and maximizing wireless power transfer efficiency (e.g. minimizing induction heating) Improvements in these areas will make possible more compact and desirable device configurations for the next generation of consumer electronics. Specifically, there is a need for a packaging material that exhibits a low water permeability, high flexibility, as well as high strength to adapt to the current development of portable electric power sources. Additionally, the packaging material should facilitate the elimination of the metal film that results in decreasing interference of wireless communication (e.g. IR, Bluetooth, Wi-Fi, etc.) in compact electronic devices. Further, there is a need for the packaging material that can protect the core of battery against external threats, such as high humidity, high temperature, and harsh chemical environments. Furthermore, there is a need for the packaging material that meets the requirement of low water vapor permeable, high melting point and resistant to most of solvents.

### SUMMARY

Before the present devices and methods along with components related thereto are described, it is to be understood that this application is not limited to the particular devices, methods, and their arrangement as described, as there can be multiple possible embodiments which are not expressly illustrated in the present application but may still be practicable within the scope of the invention. It is also to be understood that the terminology used in the description is for the purpose of describing the particular versions or embodiments only and is not intended to limit the scope of the present application. This summary is provided to introduce concepts related to a polymer-based packaging material for lithium-ion battery and the concepts are further described below in the detailed description. This summary is not intended to identify essential features of the claimed subject matter nor is it intended for use in determining or limiting the scope of the claimed subject matter.

In one embodiment, a packaging material for lithium-ion (Li-ion) battery is described herein. The packaging material for Li-ion battery may include an innermost hot sealing resin layer facing a core of a battery. The packaging material for Li-ion battery may further include an adhesive layer optionally placed at top of the innermost hot sealing resin layer. The packaging material for Li-ion battery may further include an outermost Liquid Crystal Polymer (LCP) layer laminated either on the innermost hot sealing resin layer directly, or on the top of the adhesive layer optionally placed at top of the innermost hot sealing resin layer. In one embodiment, the LCP layer may have a Water Vapor Transmission Rate (WVTR) less than or equal to 0.01 g/m²/day. In another embodiment, the innermost hot sealing resin layer has an initial hot seal temperature in the range of 100° C.-140° C.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The detailed description is described with reference to the accompanying Figures. In the Figures, the left-most digit(s) of a reference number identifies the Figures in which the reference number first appears. The same numbers are used throughout the Figures to refer like features and components.

FIG. 1 illustrates a schematic sectional view of a battery after assembly of the said battery, in accordance with an embodiment of the present application.

FIG. 2 illustrates a schematic drawing of the battery before assembly of the said battery, in accordance with an embodiment of the present application.

FIG. 3 depicts multiple structures of the Liquid Crystal Polymers (LCP), in accordance with an embodiment of the present application.

FIG. 4 illustrates a schematic cross-sectional view showing the structure of the present inverted packaging, in accordance with an embodiment of the present application.

FIG. 5 illustrates a capacity change during formation of the batteries prepared with packages of examples 1-4, in accordance with an embodiment of the present application.

FIG. 6 illustrates a charging/discharging long cycling performance of the batteries prepared with packages of examples 1-4 and aluminum package, in accordance with an embodiment of the present application.

FIG. 7 illustrates Water Vapor Transmission Rate (WVTR) data for the packaging materials, in accordance with an embodiment of the present application.

FIG. 8 illustrates AirFuel Alliance wireless charging setup, LCP battery and aluminum packed batteries, in accordance with an embodiment of the present application.

FIG. 9 illustrates a temperature of the aluminium packed batteries and LCP battery, in accordance with an embodiment of the present application.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Some embodiments of this application, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any apparatuses, devices and methods similar or equivalent to those described herein can be used in the practice or testing of embodiments of the present application, the exemplary, apparatuses, devices and methods are now described. The disclosed embodiments are merely exemplary of the application, which may be embodied in various forms.

Various modifications to the embodiments will be readily apparent to those skilled in the art and the generic principles herein may be applied to other embodiments. However, one of ordinary skill in the art will readily recognize that the present application is not intended to be limited to the embodiments illustrated but is to be accorded the widest scope consistent with the principles and features described herein.

The present application relates to a polymer-based packaging material for Li-ion battery. The polymer-based packaging material for Li-ion battery may include an innermost hot sealing resin layer facing a core of a battery, an adhesive layer optionally placed at top of the innermost hot sealing resin layer, and an outermost Liquid Crystal Polymer (LCP) layer laminated either on the innermost hot sealing resin layer directly, or on the top of the adhesive layer optionally placed at top of the innermost hot sealing resin layer.

While aspects of described polymer-based packaging material for Li-ion battery may be implemented in any number of different computing systems, environments, and/or configurations, the embodiments are described in the context of the following exemplary system.

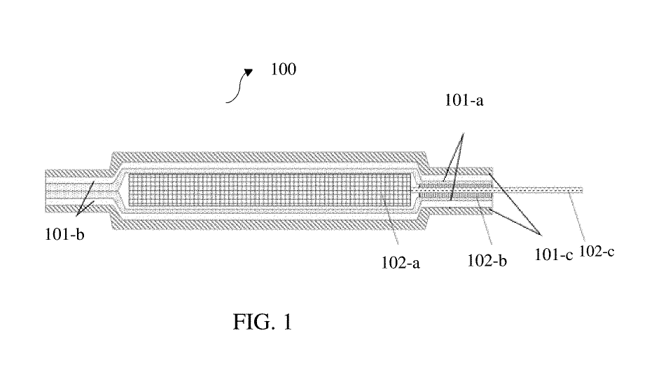

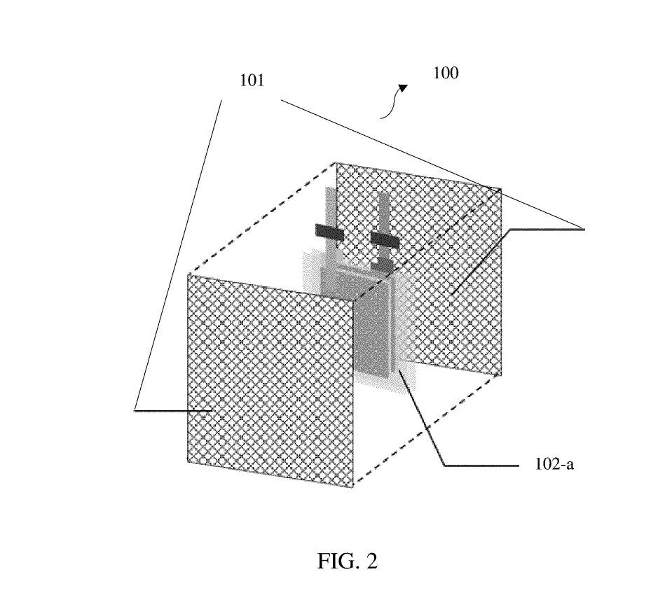

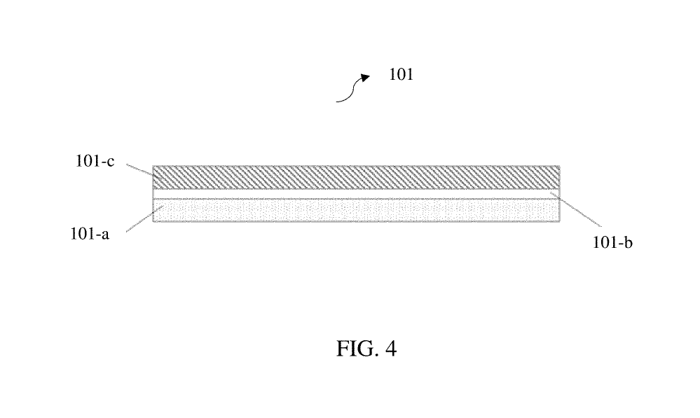

FIG. 1 illustrates a schematic sectional view of a battery after assembly of the said battery, in accordance with an embodiment of the present application. FIG. 2 illustrates a schematic drawing of the battery before assembly of the said battery, in accordance with an embodiment of the present application. FIG. 4 illustrates a schematic cross-sectional view showing the structure of the present inverted packaging, in accordance with an embodiment of the present application.

As shown in FIG. 1, the battery 100 may include a packaging material 101, a core 102-a of the battery 100, a terminal 102-c of the battery 100 and a resin 102-b attached on the terminal 102-c. In one embodiment, the packaging material 101 may include an innermost hot sealing resin layer 101-a facing the core 102-a of the battery 100, an adhesive layer 101-b optionally placed at top of the innermost hot sealing resin layer 101-a and an outermost LCP layer 101-c laminated either on the innermost hot sealing resin layer 101-a directly, or on the top of the adhesive layer 101-b optionally placed at top of the innermost hot sealing resin layer 101-a.

In one embodiment, the core 102-a of the battery 100 may include electrodes (i.e. anode and cathode), one or more current collectors such as copper and aluminum and a separator. The resin 102-b that is attached on the terminal 102-c may be made either from an Oriented Polypropylene (OPP), or a Cast Polypropylene (CPP), or the like. The terminal 102-c of the battery 100 may be made from aluminum, nickel and their polymer composite.

In one embodiment, the innermost hot sealing resin layer 101-a may be made of polyethylene, polypropylene, ethylene/vinyl acetate, or the like. Further, the innermost hot sealing resin layer 101-a may have a tensile strength within a range of 4-70 MPa. In some embodiments, the innermost hot sealing resin layer 101-a made of Low Density Polyethylene (LDPE) and Medium Density Polyethylene (MDPE) may have a tensile strength within a range of 4-16 MPa and 20-70 MPa respectively. Further, the innermost hot sealing resin layer 101-a made of casted polypropylene may have a tensile strength within a range of 30-70 MPa. The innermost hot sealing resin layer 101-a made of LDPE, MDPE and the casted polypropylene may have the Young's modulus within a range of 0.07 GPa-0.3 GPa, 0.4 GPa-1.2 GPa and 1.0 GPa-2.0 GPa respectively. Further, the innermost hot sealing resin layer 101- made of LDPE, MDPE and the casted polypropylene may have an initial hot sealing temperature within a range of 100-120° C., 120-140° C., and 105-120° C. respectively. It must be noted herein that the initial hot seal temperature refers to the minimum temperature required to conduct hot seal process. The aforementioned physical properties of the innermost hot sealing resin layer 101-a are summarized in Table 1 as below:

TABLE 1
Physical Properties of the innermost hot sealing resin layer 101-a

| | | | Casted |
|---|---|---|---|
| Parameters | LDPE | MDPE | Polypropylene |
| Tensile Strength (MPa) | 4-16 | 20-70 | 30-70 |
| Young's Modulus (GPa) | 0.07-0.3 | 0.4-1.2 | 1.0-2.0 |
| Initial hot seal temperature (° C.) | 100-120 | 120-140 | 105-120 |

In one embodiment, the adhesive used in the adhesive layer 101-b may include at least one of polyacrylic acid, polyvinyl acetate, polychloroprene, polyester, polyurethane, and combinations thereof. The adhesive layer 101-b may have a melting point within a range of 80° C. to 180° C. Further, the adhesive used in the adhesive layer may either be a liquid adhesive or a solid adhesive.

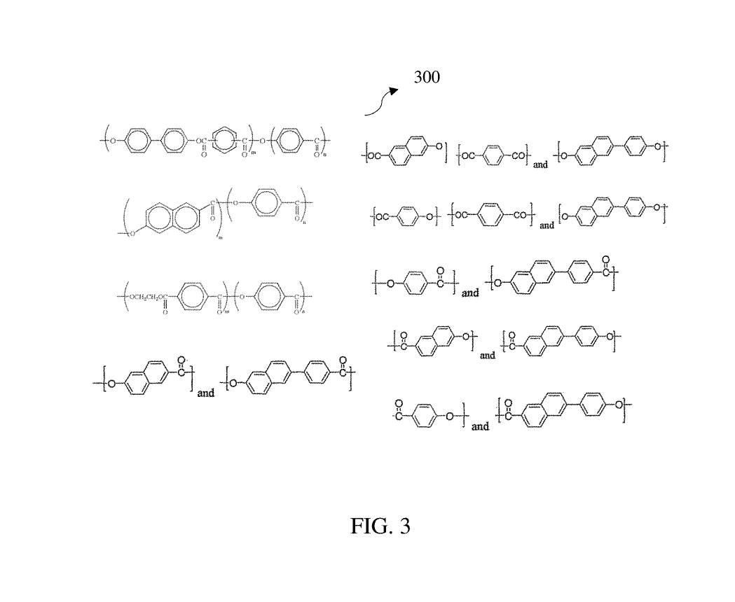

In one embodiment, the LCP used in the outermost LCP layer 101-c may include aromatic polyesters that exhibits liquid crystallinity when melted and are synthesized from monomers including, but not limited to, aromatic diols, aromatic carboxylic acids and hydroxycarboxylic acids, type 1 polymers comprising p-hydroxybenzoic acid (PHB), terephthalic acid and biphenyls, type 2 polymers comprising PHB and 2,6-hydroxynaphthoic acid, and type 3 polymers comprising PHB, terephthalic acid, and ethylene glycol. FIG. 3 depicts the multiple possible structures of the Liquid Crystal Polymers (LCP), in accordance with an embodiment of the present application.

In one embodiment, the outermost LCP layer 101-c may have a Water Vapor Transmission Rate (WVTR) less than or equal to 0.01 g/m²/day in accordance with a testing method prescribed in ASTM F-1249. Further, the outermost LCP layer 101-c may have a tensile strength within a range of 200-400 MPa in accordance with a testing method stated in ASTM D882. The outermost LCP layer 101-c may have an elongation of 30-60% in accordance with the testing method stated in ASTM D882. Further, the outermost LCP layer 101-c may have a Young's modulus of 1-4 GPa in accordance with the testing method stated in ASTM D882. Further, the outermost LCP layer 101-c may have a melting point greater than 250° C. in accordance with a differential scanning calorimetry. Further, the outermost LCP layer 101-c may have a water absorption rate between 0.02%-1% under the condition of 25° C. for 24 hours. The thickness of the outermost LCP layer 101-c may be about 50-100 μm. In a preferred embodiment, the thickness of the outermost LCP layer 101-c is about 100 μm. It must be noted that the material used for the outermost LCP layer 101-c should have the physical properties such that the material can withstand high humidity environments, high temperature environments, and harsh chemical environments. The aforementioned physical properties of the outermost LCP layer 101-c are summarized in Table 2 as below:

TABLE 2
Physical Properties of the outermost LCP layer 101-c

| Parameter (Unit) | Testing method/condition | Values |
|---|---|---|
| Tensile Strength (MPa) | ASTM D882 | 200-400 |
| Elongation (%) | ASTM D882 | 30-60 |
| Young's Modulus (GPa) | ASTM D882 | 1-4 |
| Absorption rate (%) | 25° C. for 24 hours | 0.02-0.1 |
| Water vapor transmission rate | ASTM F-1249 | ≤0.01 |
| (g/m²/day) | | |
| Melting Point (° C.) | Differential scanning | ≥250 |
| | calorimetry | |

In one embodiment, the outermost LCP layer 101-c may be applied on the liquid adhesive by means of at least one of casting or spraying. In an alternative embodiment, the outermost LCP layer 101-c may be applied on the solid adhesive by means of taping. In one embodiment, the outermost LCP layer 101-c may be laminated on the innermost hot sealing resin layer 101-a by using at least one of a lamination machine or a hot press machine.

It must be noted herein that, the use of the LCP as packaging material 101 for an electric battery has an outstanding strength at extreme temperatures and resistance to chemical corrosion, weathering and radiation. The LCP has the lowest WVTR even without the addition of fillers such as SiN, SiO and the like. Strong resistance of the LCP against moisture penetration is critical as water may poison the electrolyte resulting in battery malfunction and/or swelling. Further, the use of the LCP as packaging material 101 for Li-ion batteries may enhance communication signal strength and reduce the severity of energy loss when operating wirelessly charged, flexible and compact electronic devices. The packaging material 101 combines the outermost LCP layer 101-c with the innermost hot sealing resin layer 101-a that allows integration into a hot sealing processes. Various exemplary embodiments of the present LCP packaging material for the battery will be hereinafter explained as below.

In accordance with a first exemplary embodiment (hereinafter referred as “example 1”), the outermost LCP layer 101-c may have a thickness of about 50 μm, an acrylic adhesive tape may be used as the adhesive layer 101-b and the polyethylene may be used as the innermost hot sealing resin layer 101-a. In this first exemplary embodiment, the adhesive may be applied by taping on the outermost LCP layer 101-c. Further, the polyethylene may be placed on the top of the adhesive layer 101-b. The composite thus formed may be heated at 110° C. under certain pressure by hot press for 10 seconds to obtain a packaging material for the battery.

In accordance with a second exemplary embodiment (hereinafter referred as “example 2”), the outermost LCP layer 101-c may have a thickness of 100 μm, an acrylic adhesive tape may be used as the adhesive layer 101-b, and the polypropylene may be used as the innermost hot sealing resin layer 101-a. In this second exemplary embodiment, the acrylic adhesive may be applied by taping on the outermost LCP layer 101-c. Further, the polyethylene may be placed on the top of the adhesive layer 101-b. The composite thus formed may be heated at 110° C. under certain pressure by hot press for 10 seconds to obtain a packaging material for the battery.

In accordance with a third exemplary embodiment (hereinafter referred as “example 3”), the outermost LCP layer 101-c may have a thickness of 100 μm, an acrylic adhesive liquid (casted) may be used as the adhesive layer 101-b, and the polypropylene may be used as the innermost hot sealing resin layer 101-a. In this third exemplary embodiment, the acrylic adhesive may be coated on the polypropylene. The adhesive attached innermost hot sealing resin layer 101-a may be laminated with outermost LCP layer 101-c with machine under room temperature.

In accordance with a fourth exemplary embodiment (hereinafter referred as “example 4”), the outermost LCP layer 101-c may have a thickness of 200 μm of ethylene/vinyl acetate, an acrylic adhesive tape may be used as the adhesive layer 101-b, and the ethylene/vinyl acetate may be used as the innermost hot sealing resin layer 101-a.

In accordance with a fifth exemplary embodiment (hereinafter referred as “example 5”), the outermost LCP layer 101-c may have a thickness of 200 μm of polyethylene, an acrylic adhesive tape may be used as the adhesive layer 101-b, and polyethylene may be used as the innermost hot sealing resin layer 101-a.

Table 3 below summarizes the aforementioned five exemplary embodiments (example 1, example 2, example 3, example 4 and example 5).

TABLE 3
Summary of the structure of package material examples

| Layer | Example 1 | Example 2 | Example 3 | Example 4 | Example 5 |
|---|---|---|---|---|---|
| Outermost | 50 μm LCP | 100 μm LCP | 100 μm LCP | 200 μm | 200 μm PE |
| layer | film | film | film | EVA film | film |
| Adhesive | acrylic | acrylic | acrylic adhesive | acrylic | acrylic |
| Layer | adhesive tape | adhesive tape | liquid | adhesive | adhesive |
| | | | | tape | tape |
| Resin | Polyethylene | Polypropylene | Polypropylene | EVA | PE |
| Layer | | | | | |

In accordance with embodiments of the present application, each of the aforementioned examples may be compared to evaluate the performance of the battery 100 with the use of different polymer packaging. It must be noted herein that the packaging material 101 is one of the key components in a battery assembly. It isolates the core 102-a of the battery 100 with electrolyte forming in the atmosphere. Therefore, the material should have a low permeability towards any gases including water vapor. It also needs to have a good chemical resistant to electrolyte. Moreover, sealing must be complete and compatible with the resin 102-b attached on the terminal 102-c. Table 4 below compares the feasibility on battery assembly using different package examples as described above:

TABLE 4
Comparison of the performance of the packaging material
101 for battery assembly

| | Exam- | Exam- | Exam- | Exam- | Exam- |
|---|---|---|---|---|---|
| | ple 1 | ple 2 | ple 3 | ple 4 | ple 5 |
| Bonding between | ⊙ | ⊙ | ◯ | ◯ | ◯ |
| layers | | | | | |
| Resistant to electrolyte | ⊙ | ⊙ | ⊙ | Δ | Δ |
| Encapsulation of | ◯ | ◯ | ⊙ | X | X |
| electrolyte | | | | | |
| Compatible with | ◯ | ◯ | ◯ | X | ⊙ |
| terminal resin (4) | | | | | |
| Sealing strength | ⊙ | ⊙ | ◯ | ◯ | ◯ |

⊙ Excellent
◯ Good
Δ Fair
X Poor

It must be noted from table 4 that examples 1 and 2 enable in comparing the effect of package material thickness. As observed, the thicker outermost LCP layer 101-c exhibits a more promising life cycle performance due to lower WVTR. Further, examples 2 and 3 may compare the performance of the adhesive tape and adhesive liquid in lamination of the LCP and polypropylene. The performance may be compatible and both materials may be capable to hold the outermost LCP layer 101-c to the polypropylene layer without affecting the battery performance. Furthermore, examples 4 and 5 are common packaging materials. However, chemical resistance against chemical (and in particular electrolyte) of these common packaging materials may be weak. The battery 100 packed with these common packaging materials may result in electrolyte leakage. Hence the exemplary embodiments pertaining to examples 4 and 5 may not be recommended for battery packaging.

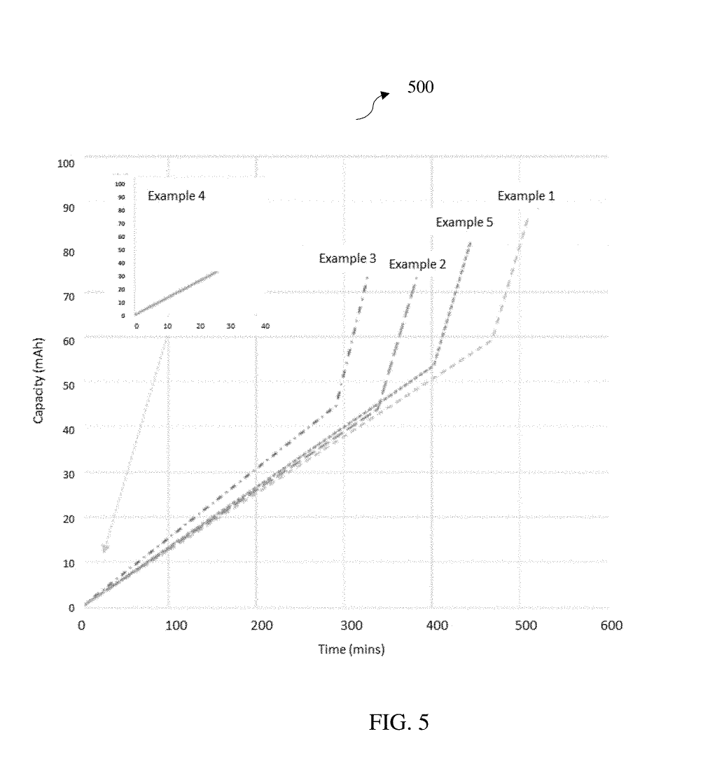

FIG. 5 illustrates a capacity change during formation of the batteries prepared with packages of examples 1-4, in accordance with an embodiment of the present application.

In one embodiment, formation of the battery is described herein. In this embodiment, five batteries may be prepared with the use of the packaging materials 101 described in accordance with the second and third exemplary embodiments as described above. All the batteries 100 may have a theoretical capacity of 80 mAh. Owing to the environmental factors, variation in assembly process and equipment conditions, a functional battery 100 may have a deviation of capacity of no more than 10 mAh from the theoretical value. Once the battery 100 is assembled, a formation is required to activate the battery 100. During the process, the batteries 100 may be kept at room condition. Each battery 100 may be charged up with a C-rate of 0.1 C at constant voltage of 3.9V (C-rate refers to the rate required to completely charge up/discharge a battery; here, for a battery 100 with a capacity of 80 mAh, this equals to a charging current of 8 mA), followed by charging at 0.5 C at a constant voltage of 4.2V until it was fully charged.

It must be noted herein that the formation of the battery 100 with the packaging materials 101 of the examples 1, 2, 3 and 5 are successful since the final capacity reaches 80±10 mAh as shown in FIG. 5. Here, the result clearly shows that packaging materials 101 described in the examples 1, 2, 3 and 5 may completely encapsulate the electrolyte in the formation state.

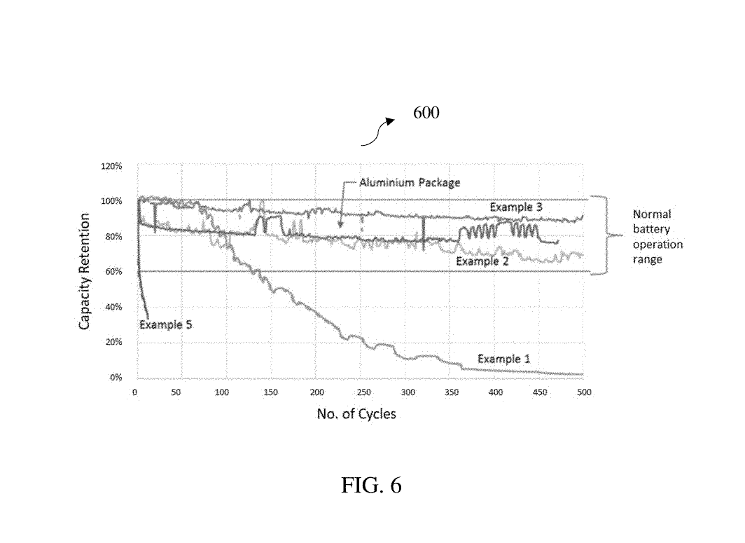

FIG. 6 illustrates a charging/discharging long cycling performance of the batteries prepared with packages of examples 1-4 and aluminum package, in accordance with an embodiment of the present application.

In one embodiment, in order to evaluate the performance of the packaging materials 101 of examples 2 and 3, the batteries 100 may be allowed to undergo a long charging/discharging cycle test. The results may be compared with a battery 100 using an aluminum laminated film (115 um) purchased from MTI Cooperation Limited as the packaging material 101. Although the examples are capable to hold and resist the electrolyte, substance from surrounding may penetrate across the packages. Gases, in particular water vapor, react with the electrolyte that reduces the durability of the battery 100 in terms of capacity and voltage.

The long charge/discharge cycle test may be conducted in room condition. The charging may be conducted at a C-rate of 0.5 C (i.e. constant current of 40 mA according to theoretical capacity, 80 mAh) at a voltage of 4.2V. Discharging may be conducted at a constant current of 0.5 C with a voltage of 3.2V. Charging and discharging may be proceeded alternatively when the capacity of the battery was full (shift from charging to discharging) or empty (shift from discharging to charging). A complete cycle may be defined as a battery 100 being completely charged and discharged.

As shown in FIG. 6, the batteries 100 with packages of examples 2 and 3 may be capable of maintaining a certain capacity (above 60%) after 500 cycles of charging. This means these packaging methods may be all flexible for the battery assembly. The battery 100 with package of examples 1 and 5 may drop out of the normal operation range in less than 100 cycles meaning that the electrolyte may be either poisoned or leaked. Hence, the packaging materials described in examples 1 and 5 are not suitable for battery packaging. The battery 100 with package of the example 4 may fail to be charged up.

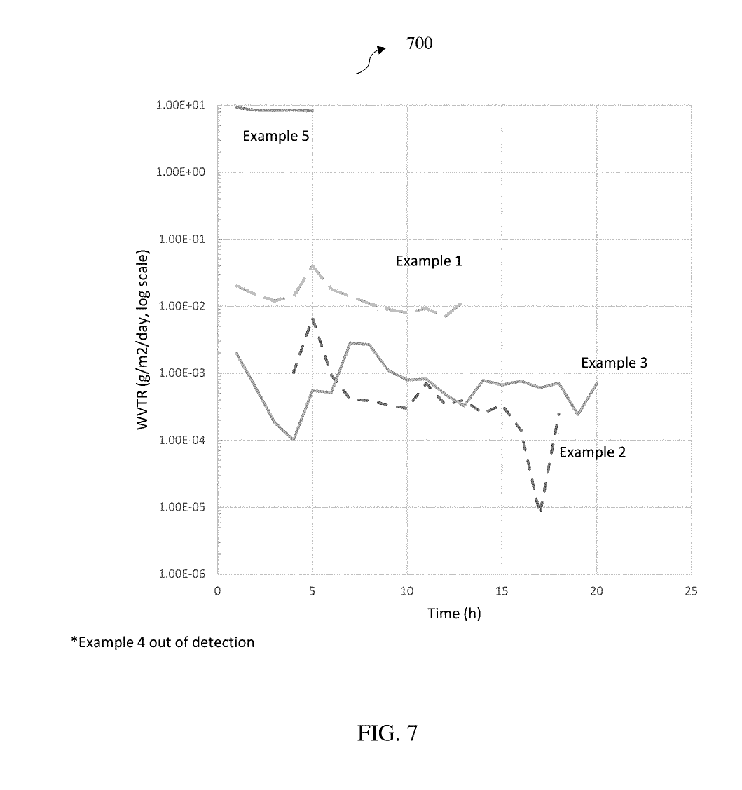

FIG. 7 illustrates water vapor transmission rate (WVTR) data for the packaging materials 101, in accordance with an embodiment of the present application. As mentioned above, the packaging material 101 may exhibit the WVTR of not more than 0.01 g/m²/day. From the graph shown in FIG. 7, the packaging materials 101 of examples 2 and 3 of the present application may prevent water molecules from penetrating into the cell/battery 100 structure and reacting with the material inside the battery 100. By achieving this WVTR value, the batteries 100 using the packaging material 101 of the present application achieve performance comparable to those using commercial packaging materials 101. The package structure described in examples 4 and 5 are all out of the minimum requirement for WVTR, hence such package structure is not suitable for the battery packaging.

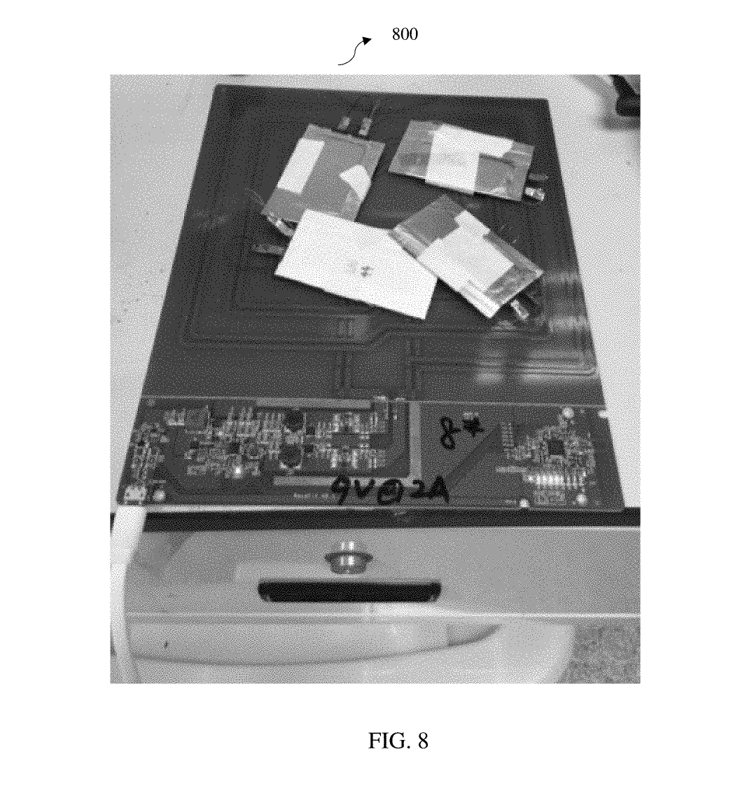

FIG. 8 illustrates AirFuel Alliance wireless charging setup, LCP battery and aluminum packed batteries, in accordance with an embodiment of the present application.

In one embodiment, the LCP battery 100 (example 3) prepared and aluminium packed batteries may be subjected to wireless charging test. The testing batteries (3 aluminium packed batteries and 1 LCP battery) may be randomly put on a A4WP wireless charging module and a receiver coil may be connected to the terminals of each battery 100 facing downward. Upon starting the wireless charging system, at t=0, both LCP and Al packed batteries show similar operating temperature, which is of about 24° C. At the first 5 minutes charging cycle, it is found that two of the aluminium packed batteries show a slight increase in temperature during the test and the batteries temperature is slightly higher (5° C.) than that of the LCP battery 100 (24° C.). Upon increasing the charging time to 10 more minutes, similar test results may be observed. The aluminium packed batteries may be kept in the same charging temperature which is slightly higher than that of the LCP battery 100. After the charging cycle is completed, the temperatures of the batteries may be back to the equilibrium stage. The result indicated that the aluminium packed batteries showed slightly higher temperature increase as compared with LCP battery 100 which may attribute to the presence of eddy current induced heating on the coil connected package surface and the heat energy may diffuse through the battery core to the detectable surface.

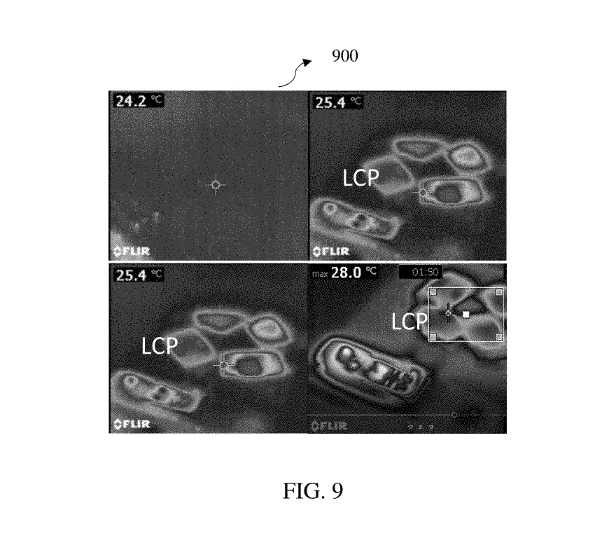

FIG. 9 illustrates a temperature of the aluminium packed batteries and LCP battery 100, in accordance with an embodiment of the present application. In one embodiment, the structure of a Li-ion battery 100 is not particularly restricted and the basic structure is constituted of the components essential for energy storage, charging and discharging.

Although implementations for the polymer-based packaging material for lithium-ion battery have been described in language specific to structural features and/or methods, it is to be understood that the appended claims are not necessarily limited to the specific features or methods described. Rather, the specific features and methods are disclosed as examples of implementations for the polymer-based packaging material for lithium-ion battery.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

What is claimed is:

1. A polymer-based packaging material for lithium-ion (Li-ion) battery comprising:
an innermost hot sealing resin layer facing a core of a battery;
an adhesive layer optionally placed at top of the innermost hot sealing resin layer; and
an outermost Liquid Crystal Polymer (LCP) layer laminated either on the innermost hot sealing resin layer directly, or
the top of the adhesive layer optionally placed at top of the innermost hot sealing resin layer;
wherein the LCP layer has a Water Vapor Transmission Rate (WVTR) less than or equal to 0.01 g/m²/day, and
wherein the innermost hot sealing resin layer has an initial hot seal temperature in the range of 100° C.-140° C.

2. The polymer-based packaging material for Li-ion battery of claim 1, wherein a Liquid crystal polymer (LCP) used in the outermost LCP layer are synthesized from at least one monomer selected from the group consisting of aromatic diols, aromatic carboxylic acids, hydroxycarboxylic acids, type 1 polymers comprising p-hydroxybenzoic acid (PHB), terephthalic acid and biphenyls, type 2 polymers comprising PHB and 2,6-hydroxynaphthoic acid, and type 3 polymers comprising PHB, terephthalic acid, and ethylene glycol.

3. The polymer-based packaging material for Li-ion battery of claim 2, wherein the outermost LCP layer has a tensile strength within a range of 200-400 MPa.

4. The polymer-based packaging material for Li-ion battery of claim 3, wherein the outermost LCP layer has an elongation within a range of 30-60%.

5. The polymer-based packaging material for Li-ion battery of claim 4, wherein the outermost LCP layer has a Young's modulus within a range of 1-4 GPa.

6. The polymer-based packaging material for Li-ion battery of claim 5, wherein the outermost LCP layer has a melting point greater than 250° C. in accordance with a differential scanning calorimetry.

7. The polymer-based packaging material for Li-ion battery of claim 6, wherein the outermost LCP layer has a water absorption rate within a range of 0.02%-1% under the condition of 25° C. for 24 hours.

8. The polymer-based packaging material for Li-ion battery of claim 1, wherein the innermost hot sealing resin layer is made of polyethylene, polypropylene or ethylene/vinyl acetate.

9. The polymer-based packaging material for Li-ion battery of claim 8, wherein the innermost hot sealing resin layer has a tensile strength within a range of 4-70 MPa.

10. The polymer-based packaging material for Li-ion battery of claim 9, wherein the innermost hot sealing resin layer of polyethylene has a tensile strength within a range of 4-16 MPa for Low Density Polyethylene (LDPE) and within a range of 20-70 MPa for Medium Density Polyethylene (MDPE).

11. The polymer-based packaging material for Li-ion battery of claim 10, wherein the innermost hot sealing resin layer made of casted polypropylene has a tensile strength within a range of 30-70 MPa.

12. The polymer-based packaging material for Li-ion battery of claim 11, wherein the innermost hot sealing resin layer has a Young's modulus within a range of 0.07 GPa and 0.3 GPa for LDPE, 0.4 GPa-1.2 GPa for MDPE and 1.0 GPa-2.0 GPa for the casted polypropylene.

13. The polymer-based packaging material for Li-ion battery of claim 12, wherein the innermost hot sealing resin layer has the initial hot sealing temperature within a range of 100-120° C. for LDPE, 120-140° C. for MDPE and 105-120° C. for the casted polypropylene.

14. The polymer-based packaging material for Li-ion battery of claim 13, wherein adhesive used in the adhesive layer is at least one of polyacrylic acid, polyvinyl acetate, polychloroprene, polyester, polyurethane, and combinations thereof.

15. The polymer-based packaging material for Li-ion battery of claim 1, wherein the adhesive layer has a melting point within a range of 80° C. to 180° C.

16. The polymer-based packaging material for Li-ion battery of claim 15, wherein adhesive used in the adhesive layer is either a liquid adhesive or a solid adhesive.

17. The polymer-based packaging material for Li-ion battery of claim 16, wherein the LCP layer is applied on the liquid adhesive by means of at least one of casting or spraying.

18. The polymer-based packaging material for Li-ion battery of claim 16, wherein the LCP layer is applied on the solid adhesive by means of taping.

19. The polymer-based packaging material for Li-ion battery of claim 1, wherein the LCP layer is laminated on the innermost hot sealing resin layer by using at least one of a lamination machine or a hot press machine.

20. The polymer-based packaging material for Li-ion battery of claim 1, wherein the core of the battery comprises electrodes, one or more current collectors, a separator.
